(19) United States
(12) Patent Application Publication
(10) Pub. No.: US 2006/0149572 A1
(43) Pub. Date: Jul. 6, 2006

(54) System and method for asset sharing

(75) Inventors: Chris Auzins, Bellevue, WA (US); Tom Brown, Austin, TX (US)

Correspondence Address: BLACK LOWE & GRAHAM, PLLC, 701 FIFTH AVENUE, SUITE 4800, SEATTLE, WA, 98104, US

(73) Assignee: SuperBorrowNet, Inc.

(21) Appl. No.: 11/027,722

(22) Filed: Dec. 30, 2004

(51) Int. Cl. G06Q 99/00; G06Q 40/00

(52) U.S. Cl. 705/1; 705/35

(57) ABSTRACT

The present invention provides for private coordination of the borrowing of items from an aggregate inventory contributed by system participants. A request is received from a system participant. The request is compared with item information associated with a universe of items maintained by the system to determine if a match for the requested title exists. If the requested item exists, a determination is made whether the item is available, whether the item owner is willing to lend it to the system participant and the relative priority of the request compared to other participant requests for the item. If approval is received, transportation of the item to the intended recipient is coordinated. The status of the item is monitored during the lending process to ensure efficient sharing of the item.

### FIELD OF THE INVENTION

This invention relates generally to systems and methods of asset inventory, publication and distribution and, more specifically, to a system and method for private coordination of the borrowing of items from an aggregate or extended inventory by program participants.

### BACKGROUND OF THE INVENTION

Borrowing a friend's book, tool or other item has long been a favorite pastime of people everywhere. Whether due to relationship, geographical proximity or similarity in intellectual interest or social pursuit, friends and associates often share resources as part of a larger distributed “divide and conquer” collaborative filter. By making items available to be borrowed, the lender is often implicitly recommending the item to the borrower based on the lender's past experience with the item, demonstrating trust in the borrower that the item will be returned and implicitly setting the stage for the borrower to reciprocate by sharing resources with the lender at some future point in time.

With the advent of the Internet, the opportunity for social and ecommerce interaction has grown significantly. Companies such as Amazon, Ebay and Napster have sought to emulate traditional social and consumer interaction on the Internet by taking advantage of the enhanced communication ability provided by the Internet. Online shops, auction sites and music sharing channels have been the result. Many of these sites provide forums for providing recommendations related to particular items. Some even provide means to rate buyers and sellers, thereby providing participants with a heightened degree of confidence that their interaction—whether it be a purchase, sale or other information sharing—will be reliable and successful.

None of the existing Internet-based systems has sought or successfully been able to emulate the socialized collaborative filtering, lending and reciprocal sharing features inherent in the lending and borrowing of items present with friends and associates in communities throughout the world. Existing systems are typically geared strictly towards the sale and purchase or rental of items rather than lending and borrowing, fail to coordinate an aggregate inventory of available items, are not able to encourage reciprocal sharing, require the transfer of ownership rights in the items or ignore critical privacy rights of the program participants.

Movie rental services such as Netflix demonstrate the limitations inherent in current systems. First, the inventory available to the renter is limited to the item stock present rather than grow with the aggregation of inventory belonging to friends in a collaborative community. Second, inventory is determined by a central institution, rather than the distributed decisions of the participants. Third, a Netflix type system, by economic necessity, imposes a limit on the number of concurrent satisfied requests per renter.

Accordingly, there is a need for a system and method that overcomes disadvantages or limitations present in existing systems and provides socialized collaborative filtering, lending and reciprocal sharing of physical items while preserving the privacy of each participant.

### SUMMARY OF THE INVENTION

The present invention includes a method for private coordination of the borrowing of items from an aggregate or extended inventory by program participants. In a preferred embodiment, the method includes the steps of receiving a request for an item from a system participant at the computer-based system; matching an item in a universe of items associated with the computer-based system with the request; allocating the matched item to the request; obtaining approval from the item owner to share the item with the system participant; transporting the item to the system participant; monitoring the status of the item; and transporting the item from the system participant to the item owner or other system participant.

In an alternative embodiment, the method further includes adding a new item to the universe of items associated with the computer-based system. In this embodiment, after receipt of the request, a determination is made whether a title record associated with the item exists. If a title record associated with the item exists, the preexisting title record is assigned to the new item. If a title record associated with the item does not exist, a new title record is created and associated with the item.

As will be readily appreciated from the foregoing summary, the invention provides a system and method for socialized collaborative filtering, lending and reciprocal sharing of items while preserving the privacy of each participant.

### BRIEF DESCRIPTION OF THE DRAWINGS

The preferred and alternative embodiments of the present invention are described in detail below with reference to the following drawings.

FIG. 1 is an overview flowchart of the system methodology of the preferred embodiment of the present invention.

FIG. 2 is a flowchart of the item addition, request creation and matching and allocating methodology of the preferred embodiment of the present invention.

FIG. 3 is a flowchart of the owner approval methodology of the preferred embodiment of the present invention.

FIG. 4 is a flowchart of the transportation methodology associated with the provision of the item to the borrower in accordance with the preferred embodiment of the present invention.

FIG. 5 is a flowchart of the item status monitoring methodology of the preferred embodiment of the present invention.

FIG. 6 is a flowchart of the transportation methodology associated with the return of the item from the borrower in accordance with the preferred embodiment of the present invention.

### DOCUMENTS INCORPORATED BY REFERENCE

The Appendices attached hereto and referenced herein are incorporated by reference. Appendix A includes an exemplar functional outline illustrating a preferred embodiment of the present invention. Appendix B includes an exemplar state request outline of the life cycles of a request made within the scope of the present invention. Appendix C includes examples of item status maintenance situations according to the preferred embodiment of the present invention. Appendix D includes examples of routing situations involving paranoid participants and symmetric trust according to the preferred embodiment of the present invention. Appendix E includes examples of routing situations involving paranoid participants and asymmetric trust according to the preferred embodiment of the present invention.

### DETAILED DESCRIPTION OF THE INVENTION

The preferred embodiment of the present invention is directed to a network-based system and method for socialized collaborative filtering, lending and reciprocal sharing of items that maintains the privacy of each participant. As used herein, a participant may include any system user. Depending on the particular status of the interaction between system users, participants may be more specifically referred to as an owner (the participant who owns a particular item), friend (a participant having been declared trustworthy by one or more other participants), current holder (the participant in possession of a particular item), requestor (the participant requesting to borrow a particular item) and recipient (the participant to whom a particular item is intended to be loaned).

While participation in the preferred embodiment of the present invention may be open to the entire public, borrowing from or loaning to particular participants may be restricted based on association between the participants. Private items may be borrowed from or loaned only among friends. Association may also be asymmetrical. For example, in the preferred embodiment, a participant has an opportunity to browse and borrow from another's collection before making the decision to reciprocate the “friendship” or, in other words, to expose items to the participant and make them available for lending. Successful reciprocity, in turn, provides an increased level of trust.

Trust as used in the present invention refers to degree of indicia present between participants or categories of participants providing an owner a means to evaluate whether the owner is willing to lend any item, or a particular item, to a requestor. The resulting level of trust is referred to as a trust privilege. In the presently preferred embodiment, all trust privileges are bundled. In other words, if the indicia of reliability of the requestor meets a certain predetermined criteria, all items are visible and all items are requestable to all friends, and all friends can request items on behalf of a friend. In alternative embodiments of the present invention, each participant is able to separately assign trust privileges for separate purposes. For example, one trust privilege may be assigned to dictate which items are visible to which friends, and a separate trust privilege may limit the ability to request an item on behalf of a friend.

The types of items available for use in the preferred embodiment of the present invention are virtually limitless. Examples include everything from relatively small personal items such as books, CDs, DVDs and tools to larger items such as equipment and vehicles to the temporary use of real estate property, such as an apartment or condo. In all situations the preferred embodiment contemplates that the lender retains ownership, title and rights in the property. The universe of items associated with the present invention include each participant's personal inventory, or the list of items owned or in the control of a particular participant; the list of physical items owned or in the control of a particular community of friends or participants on the system; and public inventory, or the list of all items that are available for sharing regardless of friendship or association between a lender and borrower.

Aggregate inventory, or item inventory that is available for loan or use by a participant on the system, is preferably composed of the aggregate personal inventory of those other participants who have declared the participant to be a friend. Aggregate inventory is always relative to a particular participant. The participant's aggregate inventory increases as the participant is added as a friend by other participants. Similarly, the participant's aggregate inventory is reduced if one of the participant's friends decides to terminate the friendship. Such an event may terminate or regress unsatisfied requests for items that are no longer available. In an alternative embodiment, extended inventory, or inventory that includes items from the friends of the participant's friends may also be available for use within the system (for example in certain special cases of Item Proxy and Brokering with Privacy, described below),

In the preferred embodiment, a participant may wish to ignore public items and restrict the community of those who can loan a desired title to trusted participants or “friends.” If the participant ignores public items, the participant incrementally increases the participant's aggregate inventory only when designated as a friend by other participants. Unless a participant is trying to borrow a rare title or the participant cannot persuade (real world) friends to join the system and contribute to the aggregate inventory of items, it makes sense to filter out public items. However, if the participant desires to borrow a public item, the participant will increase the chance of success by making a request within the participant's geographically local community.

In the preferred embodiment, an item can be loaned or items exchanged in a variety of means. The item can be transferred at a physical location if the geography of the participants makes this option feasible (e.g., the participants work in the same office). In this situation, the lender is guaranteed direct contact with the borrower, which may affect the willingness of the lender to participate with an otherwise unknown (or less known) borrower. Alternatively, the item can be shipped by any of a variety of known means, including USPS, Federal Express, UPS, etc. At the parties' option, the shipping can be tracked. In this case, barring some security for the item loaned, the lender may be much less willing to loan an item absence a higher degree of confidence in or experience with the borrower. Accordingly, communities of friends can facilitate a wider range of types of exchanges whereas transactions with remote or less known participants may require too much trust.

System Overview

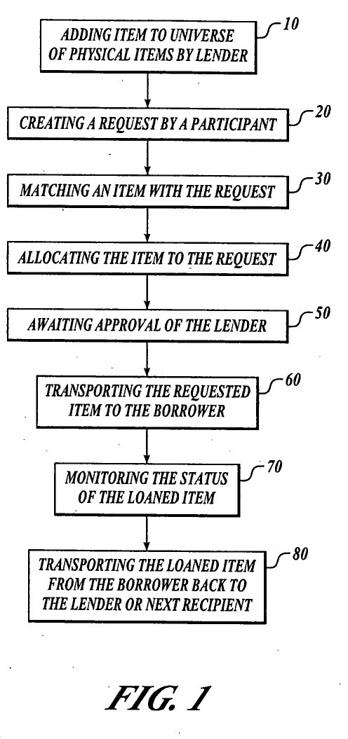

The preferred methodology is described with reference to the processes leading from the introduction of an item into the system to a request creation by a system participant through the allocation, approval and shipping to and from the recipient of the item. With reference to FIG. 1, the present invention includes the following stages: adding an item to the universe of items associated with the system by an owner participant or lender 10; creating a request by a system participant or requestor 20; matching an item with the request of a requestor 30; allocating the item to the request 40; awaiting approval of the owner 50; transporting the requested item to the recipient 60; monitoring the status of the loaned item 70; and transporting the loaned item from the current holder back to the owner or to the next recipient 80, completing the process. Each of these stages is discussed below.

Adding Items and Requesting Items

The present invention incorporates two of the overview stages discussed above: the process of adding items to a participant's collection and the process of creating requests. Each participant who desires to borrow and make use of something will create a request to express that interest. In the preferred embodiment, both processes incorporate the use of a “Title ID”—the particular title associated with an item—and an Item ID—a particular instance of a titled item.

When an item is added to the system, it is assigned either a preexisting or a newly assigned Title ID. If the Title ID record already exists, the new item is assigned the Title ID of the existing record. If the Title ID record does not exist, a new and unique Title ID record is created. The fields in the Title ID record may be populated manually by the participant or in an automated fashion, for example, by use of a third party application. When a request is added to the system, it must be associated either with a Title ID or an Item ID. In the preferred embodiment, if the new request is associated with an Item ID, then the Title ID is determined based on the Item ID.

In a preferred embodiment, in order to know what to request, each participant must be able to determine available inventory through searching and browsing. These actions expose the participant to the available aggregate inventory by filtering it in various ways, including user-directed (e.g., search criteria) and system-directed (e.g., age appropriateness).

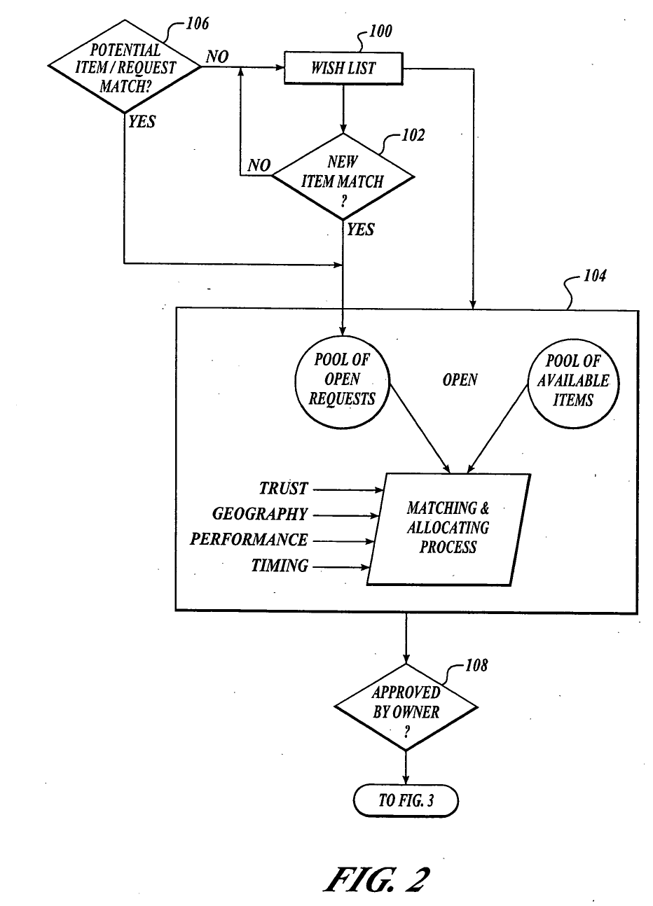

With reference to FIG. 2, block 100 is a wish list block where any unsatisfiable participant requests for titles are maintained. A request is placed in and remains at block 100 if (a) the request has no associated Item ID and (b) no item exists in the requestor's aggregate inventory that can satisfy the request, for example, because the requestor is not trusted by the owner.

At decision block 102 a determination is made whether there is an existing request in the wish list state that the newly added item can serve. In a newly initialized system where there have been no prior participant requests made to the system or items added, the logic awaits additional new items or a request. If the Title ID record already exists when the item is added, the implication is that there might be a request this new item can serve. Accordingly, the logic proceeds to open block 104 to match and allocate the item with a request. If the Title ID record does not exist when the item is added, there is no need to check for requests since such a request would have already generated a new and unique Title ID record when the request was created.

For example, at decision block 102, when a new item is added, a determination is made whether there is a potential match between the item and any of the pool of requests in the wish list block 100. This analysis includes two tiers:
First Degree. If the Title ID matches and the requestor is trusted by the owner of the new item, then a potential match exists. When a potential match exists, the request may (a) be converted directly into an active request in the Open state, or (b) the requestor may be notified that the same transition can be manually initiated. This choice is preferably configurable by the user.
Second Degree. If the Title ID matches and the requestor is not a friend of the owner, but is the friend of a friend of the owner, then a potential brokering relationship is identified. At this point the system either (a) notifies the intermediate party of the opportunity, or (b) notifies the requester that an opportunity exists and may dictate whether the opportunity is pursued. This choice is preferably configurable by the user.

All new requests start at decision block 106. In order to create a request, a participant identifies what to borrow either by making a title request or an item request. A title request is a request for a particular title (e.g., as identified by the Title ID), but not a particular instance of the title (i.e., the Item ID is left blank). For example, a request to borrow a Spiderman DVD is a title request. The participant is interested in borrowing any copy of the Spiderman DVD. In contrast, an item request is a request for a particular instance of a title; in other words, a request to borrow a specific, unique instance of the title. For example, a request to borrow a particular participant's Spiderman DVD.

When a participant creates a request for a title, a determination is made whether there exists a Title ID for the desired title. If a Title ID record already exists, the new request is assigned the Title ID of the existing record. If the Title ID record does not exist, a new unique Title ID record is created, as discussed below.

For example, at decision block 106, when a request is added, a determination is made whether there exists an item that can satisfy the request. If an Item ID is specified in the requests, then the answer is affirmative since the participant specified the item. On the other hand, if the request includes only a Title ID, then a determination is made of whether an item with the Title ID is available by anyone who trusts the requestor. If no item exists that can satisfy this request, then the request proceeds to the wish list block 100. If an item does exist that can satisfy this request, then the request is placed (without an Item ID) in the open block 104.

Within the context of a given request, there may be up to three direct participants and up to two indirect participants. Direct participants may include:
Borrower or Recipient (Rc)—This is the participant who will actually receive the item and put it to use.
Lender or Owner (O)—This is the participant who owns the item, and must grant permission for its circulation.
Requestor (Rq)—This is the participant who makes the request to the owner on behalf of the Recipient for the item. While this participant will most commonly be same as the recipient, the requestor may also be the owner of the item or a third participant who has the trust of both the Owner and the Recipient.
   Indirect participants may include:
Previous Recipient (Rc−1−)—This is the participant who has the item immediately before the recipient in the current request. This participant may be asked to ship the item directly to the Recipient.
Next Recipient (Rc+1)—This is the participant who gets the item after the current recipient. The current recipient may be asked to ship the item directly to this participant.

For items with a specific, fixed title, for example popular media (music CDs, movie DVDs) or common equipment (camping tent), when making a request for which a Title ID record does not already exist in the database the fields in the Title ID record are preferably only be populated by a third party database application. The participant is not allowed to manually populate the fields in the Title ID record for the purposes of generating a request. This discourages a participant from requesting and creating an inaccurate Title ID for an item or a redundant Title ID record for something that already exists in a third party database. In the latter case, if a trusted friend or other accessible participant owns or later acquires the desired item using a proper third party Title ID record, the system will not be able to match the item with the request since each will have a different Title ID.

In yet another embodiment, with particular types of items, the system may prompt the participant to select one of a predefined number of acceptable titles for items taken from an existing database, for example, a third party application, or a list of generic Title IDs preassigned to each common item. Alternatively, participants may manually create Title ID records for requests for such items, particularly obscurely titled items, which in turn could be matched with items by reference to regular expression patterns within the participant-created Title ID (in addition to Title ID matching).

When manually entering title information, the owner can specify that a title is a “private title.” A private title means that the item is unique to that particular owner, for example, because the item is something that the owner created. This will prevent any other participant from adding an item of the same title. The advantage of this private title option relates to privacy. If a first owner enters a title for an item the owner personally created, when any other owner attempts to add an item by matching a title, the system reveals the title and related item information by way of informing the second owner of the preexistence of the first owner's item. This allows participants who do not have access to the item and are not authorized to borrow the item from nevertheless obtaining the item information. By using a private title designation, this information can be restricted from access in such situations.

When creating a request, although the participant can select any title present in a third party title database or the present system's proprietary database, the participant may only select items that are available through the participant's aggregate inventory. Regardless of whether the participant makes a title request or an item request, at block 106 the process determines whether one or more items in the participant's aggregate inventory has a Title ID that matches the Title ID specified in the request.

If an item in the participant's aggregate inventory matches the request (as will always be the case if the participant selects an active item), the logic proceeds to open block 104. If no item in the participant's aggregate inventory matches the request, the logic proceeds to the wish list block 100 as there is no available transition along which the request can be served. A request will typically stay in the wish list block 100 until the request is deleted or suspended by the owner, an item with the requested Title ID is added to the participant's aggregate inventory (for example by a friend), the participant adds the title to the participant's own personal inventory, or via item brokering (described below).

As new items are added to the inventory, the logic proceeds from the wish list block 100 to the decision block 102, where a determination is made whether the participant's requested title matches a new item in his aggregate inventory, preferably according to the methodology set forth above. If the wish list request matches an item in the requestor's aggregate inventory, the request proceeds to the open block 104. If the wish list request does not match any item in the requestor's aggregate inventory, the request returns to the wish list block 100.

Matching and Allocating Items

Matching an item with the request and allocating that item to the request occurs at open block 104. Open block 104 performs several functions. First, it maintains a pool of open requests and a pool of available items. In the preferred embodiment these are maintained in one or more system databases. Second, it uses a matching process to match open requests to available items.

In the preferred embodiment, a request is matched to an item when the request is assigned an Item ID. It is at this point that the owner is notified to approve the request (or, in the case of an item request, “pre-approve” it if the item is currently loaned out to a different participant). Participant notification for this or any other notification described herein may take any number of different forms. For example, participants may be notified electronically via email, facsimile, pager, telephone message, mail or other automated or manually initiated communication method. Each participant is preferably able to customize the method and timing of the notification. In an alternative embodiment, status reports may be similarly generated on a periodic basis that updates the participant on the present location and anticipated destination of the participants loaned items (where owned) or borrowed items.

For item requests, matching is automatic as the requestor has already specified the item. However, for title requests, the request is not matched to an item until an item with the desired Title ID becomes available. It is only after the request is matched with an available item that owner approval is sought at block 108.

Although this design decision may affect latency for acquiring owner approval for a title request, it compensates by ensuring the request is allocated to the first available item. If all available items are loaned out and the requestor is more concerned about knowing whether the owner will decline the title request, the requestor may choose to submit an item request.

An item is allocated to a request when the item is available and the request has higher precedence than any of the other unallocated requests competing for the item. All title requests are immediately allocated at the time they are matched. When a request is matched (regardless of whether it has been allocated), the lender is asked to approve or deny the request. The preferred matching and allocation methodology is discussed in greater detail below.

Given a set of items (each having an associated Title ID record) and a set of requests by participants, at open block 104 the present invention determines (1) which items satisfy which requests, and (2) in which order the items will satisfy requests. These questions are typically answered on two occasions: when an item is newly available (either as a newly added item or a previously loaned item that has become available again), and when a new request is added to the system. Each item is associated with a queue to determine order of access to the item. When an item is newly available, both of the above questions can be answered by an asking “Who's next for the item?” When a new request is created, the question would be “Is an appropriate item available?”

If an item request is made, the request is preferably placed in a simple first-in, first-out queue. When the request reaches the head of the queue, the requestor is granted access to the item (subject to owner approval).

If a title request is made, any item in the requestor's aggregate inventory may satisfy the request. In this case, the requestor is getting in line for all of the items in his aggregate inventory with the correct Title ID. When the request reaches the head of the queue for an item, it is also removed from the queues of the other items. If the title request is subsequently denied by the owner of the matched item, then this will be noted on the request (to prevent the same item matching up with a title request repeatedly), and the title request will return to the queue for all appropriate items with the same priority it had before.

A variety of factors may influence the order in which requests are satisfied in the matching and allocation process of open block 104. In the preferred embodiment, the order in which items are matched and allocated are a function of the requestor, the owner and the priority methodology, which in turn relies on factors such as the level of trust that exists between the owner and requestor; the geographic proximity between the owner and requestor; the performance history of the requestor; the timetable requested by the requestor and any competing timing considerations associated with the particular item.

The methodology first checks to see if the current request already points to the request that should come next. Manipulation of this field is how requestors and owners can manipulate the order in which requests will be satisfied. If this field is not occupied, then the methodology looks to the set of open requests for the item and determines which one is to be fulfilled next based on the noted factors.

Owner of the Item

The owner of an item may manipulate the queue associated with the item at anytime before the item has actually been shipped to the recipient. This is preferably accomplished by prioritizing or chaining requests together with the aforementioned next request field, thereby determining the order in which the requests are served.

Requestor for the Item

When requests are submitted, the requestor may specify a chain of recipients to be satisfied in a particular order. This order only affects the submitted requests, and may be overridden by the owner.

Priority Methodology

Absent a preset next request (resulting from any order manipulation by the owner or requestor), the present invention determines the order in which requests are filled using one or more of a variety of priority routines described below. One of the considerations in this analysis is to minimize the wait time for requestors awaiting an item.

Simple Queue. The next request is the one that is oldest according to a timestamp on the request. This is also referred to as first-in, first-out priority, or a FIFO queue. The timestamp used is the request submission timestamp. The advantage of this method is its simplicity; people understand it and are used to it. The disadvantage of this method is that it may result in inefficient routing. If in-town and out-of-town requests are mixed in time, the item may end up traveling much farther than necessary, thus creating more expense.

Time-To-Finish. The next request is based on which recipient is estimated to be finished first with the item. This estimate would include the estimated shipping time from the current location of the item to the recipient and the estimated length of time for the recipient to make use of the item (which is category dependent). This method gives preference to geographically proximate participants and participants with a history of quick usage. The advantage of this method is that is separates in-town from out-of-town requests, thus reducing total shipping costs and time spent traveling. One disadvantage of this method is that the participant performance measurements may not be reliable, particularly for newer participants. Initially there will not be much historical performance information on which to rely. As a result, substitute default measurements must be used. This aspect is also subject to participant reporting vagrancies. Often a recipient will not acknowledge an item's receipt until a point in time after the participant receives the item, which may lead to a deceptively small turnaround time. Another disadvantage of this method is the complexity involved, for example, in separating performance by item category (DVD vs. book, etc).

Time-To-Finish w/queuing. The next request is based on a combination of the time-to-finish rating and a simple first-in, first-out queue. This method determines a cluster of participants based on the time-to-finish rating then, within that cluster, ranks them according to a first-in, first-out priority. The advantage of this method is that is separates in-town from out-of-town requests within these clusters and still uses participant historical performance. As a result it filters out much of the potential participant manipulation by focusing on only large differences in participant performance. The disadvantage is the complexity involved in the method.

Distance w/queuing. Given the anticipated unreliability of user performance measurements and the complexity referred to above, a good approximation of the Time-to-Finish methodology is the Distance w/queuing methodology. This method sorts requests based on distance from current location and groups them into local and non-local requests. Both subgroups are queued by request submission time with the local requests placed before non-local requests. In the preferred embodiment, participants with no address listed would always be considered non-local. This methodology has the advantage that distance is simple to measure.

Approval Decision by Owner

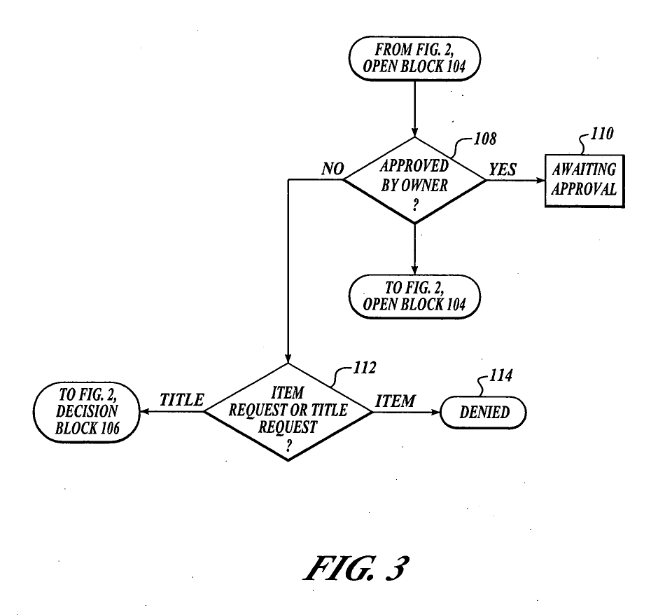

For all unapproved requests, the owner is notified to approve or deny the request when it has been matched. As shown with reference to FIG. 3, a request leaves the open block 104 when an item has been allocated to it and proceeds to decision block 108 to determine the status of owner approval. At this instant, unless the request was an item request that had to wait for the item to become available, it will always have an unspecified approval and the logic will proceed to block 110 to await approval from the item owner. For the case of the unfulfilled item request, the approval might still be unspecified when it leaves the open block 104, but since the request was matched earlier in the process, the owner has had a window of opportunity to approve or deny the item request.

A request will typically remain at decision block 108 pending owner approval or denial of the request. If the request is denied, the logic proceeds to decision block 112. At decision block 112, a determination is made whether the request was an item request or a title request. If an item request is denied, the logic proceeds to block 114, where it is retired. If the owner of an item denies a request, the request will not be able to be filled unless there is a subsequent change in the owner's approval. Because the item request is retired when denied, this will require a new request. If a title request is denied, the denied Item ID will be recorded and associated with the request so that it will never be matched with the request again, thus preventing the same owner from having to repeatedly deny the same request. In this case, the logic proceeds to decision block 106 to determine whether a different instance of the title exists in the participant's aggregate inventory. If so, the logic proceeds to open block 104. If not, the denied title request will be set to the wish list block 100 to await the addition of a new item of the requested title.

“Mooch Meter.” This is a simple per-borrower metric designed to assist an owner in the decision to approve a request. Although an owner expresses trust that a potential borrower will return the loaned item in a satisfactory way when the potential borrower is added by the owner as a friend, the owner might be interested to know if the potential borrower is taking substantially more from the system than the potential borrower is contributing. The Mooch Meter may be used to decide whether or not to approve a request in general based on the answer to a question such as “Does this person return things slowly?” It may also be used in the decision whether to approve a particular request based on the answer to the question “Does this person have a bunch of my stuff already?” or “Does this person have lots of other people's stuff?”

The Mooch Meter is preferably a composite measurement of a wide variety of data components related to the potential borrower. Examples of performance data components includes:
Number of items currently with the borrower
Number of items owned by borrower with owner
Borrower's turnaround time
Number of items lost or damaged by borrower
Number of items lost or damaged by borrower and owned by owner
Historical number of items borrowed by recipient
Historical number of items borrowed by owner.
Current demand for the item.

Performance matters more when demand is high. If there is low demand for an item, fewer participants are affected by latency. Thus, in the preferred embodiment, when demand is low, performance measurements such as turnaround time and the proxy privilege are preferably less significant. In addition, using numbers that span all of a borrower's activity may present privacy issues. Two counterbalances, the preferred embodiment (1) focuses on only the numbers related to the particular relationship (between the owner and the requester) or (2) only present a composite “measurement,” rather than allowing the owner to see each separate data component related to the requestor's overall performance behavior.

Transporting the Requested Item to the Recipient

Eventually, once an item has been added by its owner, requested by a requestor, and the owner approves the request, the item needs to make its way to the recipient.

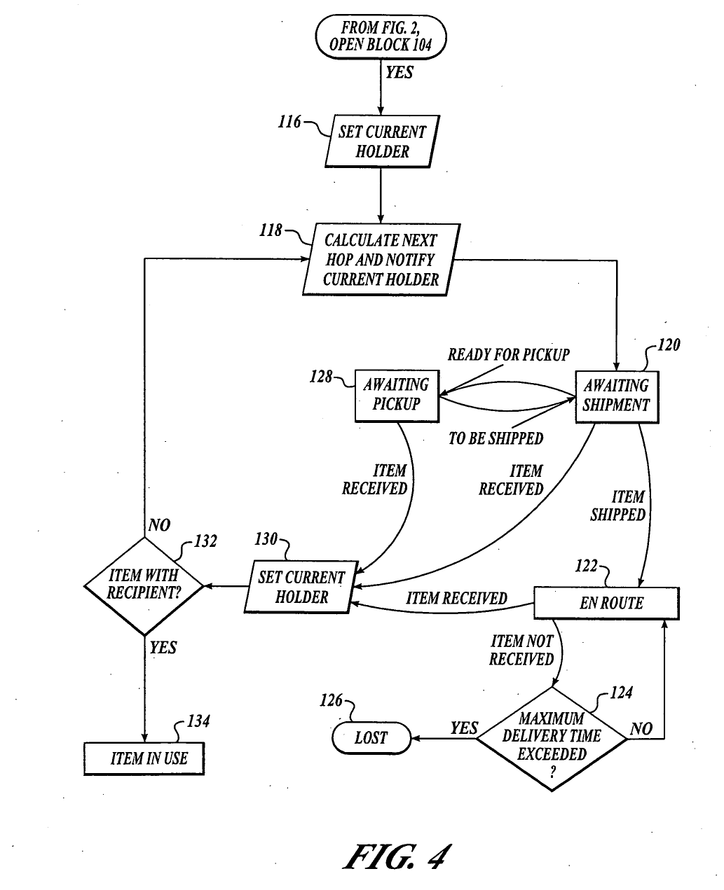

With reference to FIG. 4, if the owner approves the pending request, the logic proceeds to block 116, where the current holder of the item is determined and associated with the request. In the preferred embodiment, the routing of the item to its recipient is then implemented using an iterative looping methodology. At block 118, the next “hop” of the item is determined. The next hop is not necessarily to the recipient (or the final destination of the item) until the final pass of the loop. For instance, if the current holder is not the owner, the item may need to return to the owner on the first pass of the loop methodology prior to being transported to the recipient on a subsequent pass of the loop methodology. The item routing methodology is preferably dependent on trust relationships and privacy settings, as explained in greater detail below.

As part of the next hop determination at block 118, the current holder of the item is notified that the item should be shipped from the current holder to the next hop. The recipient and the next hop may be the same participant. If the recipient and next hop are not the same participant, the current holder's notification will not include any private information about the recipient. The next hop may be informed where to forward the item to (1) when the next hop is notified that the item has shipped, (2) when the next hop acknowledges receipt of the item, or (3) both.

The logic proceeds to block 120 where the request remains until the item has been shipped. The current holder may ship the item to the next hop, manually deliver it or arrange for the next hop participant to pick it up. If the current holder decides to ship it or deliver it, the logic proceeds to block 122, where current holder updates the request's status to indicate that the item is en route. If the period that the item is en route exceeds an excessive delivery time, which determination is made at decision block 124, the logic determines that the item has been lost at block 126. If the item is determined to be lost, the owner, current holder, next hop and requesters of unfulfilled item requests are preferably notified of the status of the item.

Alternatively, the next hop participant will acknowledge the receipt without the request passing through block 122. In this instance, if the current holder decides to arrange for the next hop participant to pick it up, either the current holder will update the request's status to show that the next hop participant is awaiting pickup (at block 128) or the next hop participant will acknowledge the receipt without the request passing through block 122 and instead proceeding directly to block 130, where the current holder is reset to indicate the present possessor of the item. At decision block 132, a determination is made whether the recipient has received the item. If the recipient has not received the item, it is presumed to be in transit at an intermediate hop location, and the logic proceeds to block 118 there the loop methodology is restarted. If the next hop participant is the recipient, then the logic proceeds to block 134, indicating that the item is in use with the intended recipient.

In the preferred embodiment, any time an item is not in the owner's possession the owner may recall the item. The item may be in use with the recipient, it may be awaiting shipment or pick-up, or it may be en route to an intermediary hop or to the recipient. When recalled, regardless of the status of the request, the routing loop is executed until the item returns to the owner.

Monitoring the Status of the Loaned Item

In the preferred embodiment, once a request exists for an item to fulfill and transportation has been deemed appropriate, the item is preferably transported from the current holder to the recipient according to one or more rules:
In general, the item will go directly from who's got the item (or “Current Holder”) to the next recipient of the item.
When an item is with a recipient and the recipient declares that the item is no longer in use, the system checks to see if a different participant has requested the item. If the next request exists and has been approved by the owner, then the item is ready to be shipped and the current recipient is notified to do so. Otherwise, the item is IDLE_WITH_BORROWER.
Even if a recipient has been notified to ship the item to the next recipient, the recipient may choose to return the item to the owner instead.
If an item is IDLE_WITH_BORROWER longer than a predetermined threshold (IDLE_THRESHOLD), then the current holder of the item may be asked to return it to the owner. In the preferred embodiment, each user (owner and recipient) can determine a personal idle threshold value. The value used for IDLE_THRESHOLD will be the minimum of the owner's and recipient's personal idle threshold values.
A recipient is not required to keep the item for the entire IDLE_THRESHOLD period. At any point when the item is IDLE_WITH_BORROWER, the recipient may return the item to the owner.
At any point when the item is not with the owner, the owner may recall the item. At this point the item is marked for return to the owner and relevant participants are notified of the item's recalled status.

Other events may affect item routing. For example, if an item is declared to be lost, then the owner is notified and the item status is changed to reflect this. The item is then placed out of circulation, any further requests dependent on this item are cancelled and the participants notified. Likewise, if an item is declared to be damaged beyond use, the item should be returned to the owner so that the owner may evaluate and confirm this. If an item is declared to be damaged but still usable, the damage description is noted for the item, the owner is notified of the item status, and thereafter the item may continue to be shared.

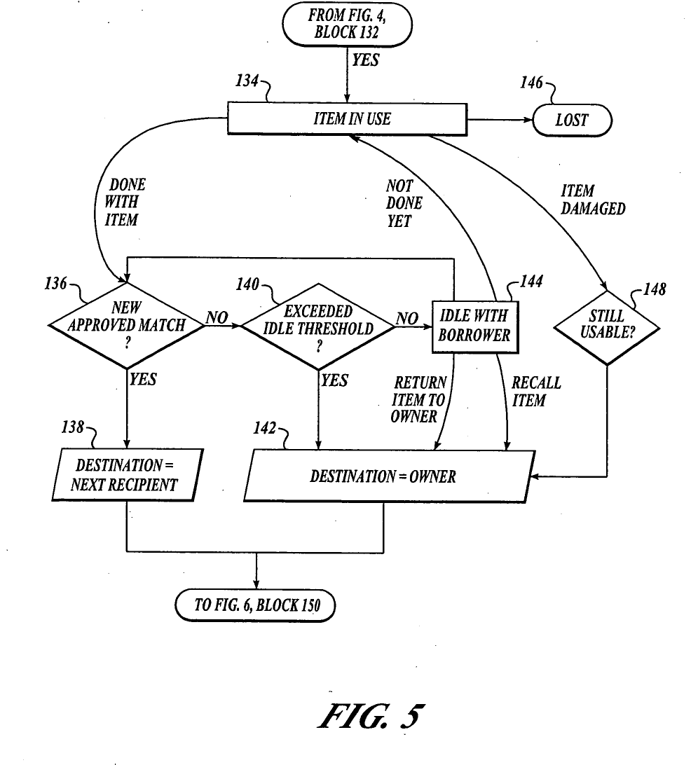

The loaned item monitoring process is described more specifically with reference to FIG. 5. At block 134 the item is in use with the recipient. When an item is with a recipient and the recipient declares that the item is no longer in use, the logic proceeds to decision block 136 where a determination is made whether a different participant has requested the item and the request has been approved. If the next request exists and has been approved by the owner, then the item is ready to be shipped. The logic proceeds to block 138 where the methodology determines the next hop, which may be to the next recipient or the owner. If at decision block 136 there is no determination made that a match is pending, the logic proceeds to decision block 140.

At decision block 140 a determination is made whether the period of time the item has been idle with the recipient exceeds a predetermined threshold period. If a predetermined threshold period is exceeded, the current holder may be asked to return the item to the owner. The logic proceeds to block 142 where the item is returned to the owner. If, at decision block 140, the threshold period has not been exceeded, the logic proceeds to block 144, where the status remains IDLE_WITH_BORROWER. At this point the recipient may choose to return the item to the owner, or revert the item back to the IN_USE status.

A recipient is not required to keep the item for the entire threshold period. At any point when the item is IDLE_WITH_BORROWER, the recipient may return the item to the owner. Likewise, at any point when the item is not with the owner, the owner may recall the item. At this point the item is marked for return to the owner and relevant participants are notified of the item's recalled status.

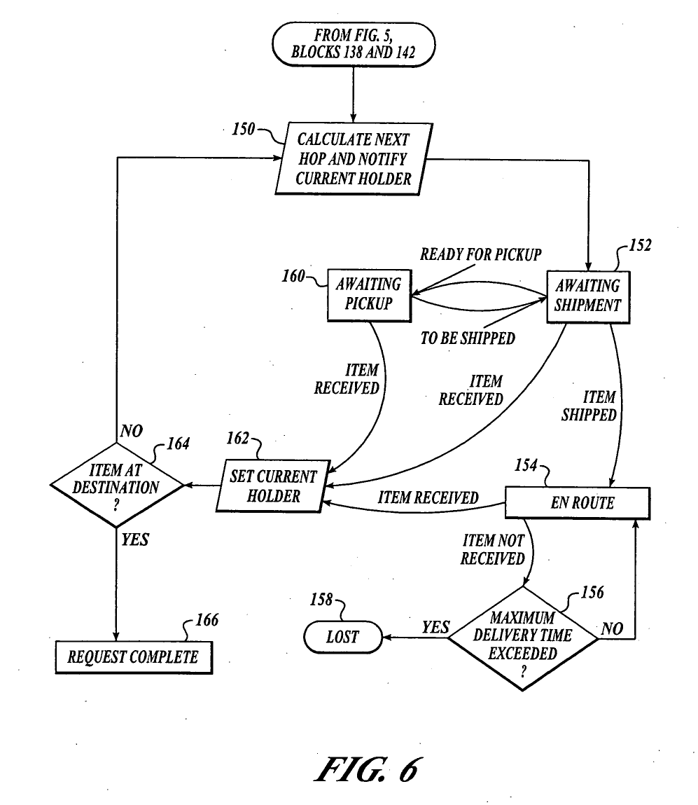

Other events may affect item status. An item in use may be declared to be lost (block 146), whereupon the owner is notified, the item status is changed to reflect this and the item is then placed out of circulation. If an item is declared to be damaged the logic proceeds to decision block 148, where a determination is made whether the item is still usable. If an item is declared to be damaged beyond use, the item is returned to the owner so that the owner may evaluate and confirm this status. If an item is declared to be damaged but still usable, the damage description is noted for the item, the owner is notified of the damage, and thereafter the item may continue to be shared. From either block 138 or 142, the logic proceeds to transportation methodology (FIG. 6).

Attached as Appendix C hereto are examples of item status maintenance situations according to the preferred embodiment of the present invention.

Transporting the Loaned Item from the Borrower to the Owner or Next Recipient

Analogous to the process that occurs to transport the item to the recipient is the process to transport the loaned item from the borrower back to the owner or next recipient. With reference to FIG. 6, at block 150 the next “hop” of the item is determined. As explained above, the next hop is not necessarily to the destination until the final pass of the loop. For instance, if the item is to proceed from one recipient to the next, it may be routed through the requestor of the owner, but the destination is the next recipient throughout. The item routing methodology is preferably dependent on trust relationships and privacy settings, as explained in greater detail below.

As part of block 150, the current holder is notified to ship the item to the next hop. The next hop is notified once the item has been shipped (or is ready for pickup). The recipient and the next hop may be the same participant. If the recipient and next hop are not the same participant, the current holder's notification will not include any private information about the recipient. Upon acknowledging receipt of the item, the next hop will be notified where to forward the item.

The logic proceeds to block 152 where the request remains until the item has been shipped. The current holder may ship the item to the next hop, manually deliver it or arrange for the next hop participant to pick it up. If the current holder decides to ship it or deliver it, the logic proceeds to block 154, where current holder updates the request's status to indicate that the item is en route. If the period that the item is en route exceeds an excessive delivery time, which determination is made at decision block 156, the logic determines that the item has been lost at block 158. If the item is determined to be lost, the owner, current holder, next hop and requestors of unfulfilled item requests are preferably notified of the status of the item.

Alternatively, the next hop participant will acknowledge the receipt without the request passing through block 154. In this instance, if the current holder decides to arrange for the next hop participant to pick it up, either the current holder will update the request's status to show that the next hop participant is awaiting pickup (at block 160) or the next hop participant will acknowledge the receipt without the request passing through block 154 and instead proceeding directly to block 162, where the current holder is reset to indicate the present possessor of the item. At decision block 164, a determination is made whether the destination has received the item. If the destination has not received the item, it is presumed to be in transit at an intermediate hop location, and the logic proceeds to block 150 there the loop methodology is restarted. If the next hop participant is the destination, then the logic proceeds to block 166, indicating that the request has been completed.

As explained above, transportation or shipment of an item from one user to the next can take any variety of forms, such as deliver the item personally (e.g., to the recipient's residence, office, or other place) or have it delivered by a third party (interoffice mail, USPS, UPS, etc). The current holder also has the option to notify the recipient that the item will not be shipped, but rather will be made ready for the recipient to pick it up at a specified location.

Once the system has determined where the item is intended to go (i.e., the destination), generally it will be shipped there directly. However, there are a variety of factors, including privacy and trust issues, which are implicated in shipments among owners, recipients and various intermediaries.

Micro-Routing (How Item Goes from Point A to B)

In the preferred embodiment, by default, participants are assumed to be open to receiving requested items from anyone that may currently have it, and that such a person may be given sufficient information to make this shipping possible. This means sending a participant's information (i.e. address) to a party who may not be trusted by the participant. In an effort to operate the present invention in a manner sensitive to participants' privacy concerns, the preferred embodiment incorporates a PARANOID participant methodology.

The PARANOID participant methodology limits information dissemination only to participants that have been assigned or earned a predetermined degree of trust. In the preferred embodiment, this property is only pertinent to shipping/routing; it has no affect on the visibility or requestability of an owner's inventory. A participant may always be asked to ship an item to anyone (trusted or not). If an item is determined to be en route to a paranoid participant, and the current holder is not a trusted party of that paranoid participant, then a routing conflict exists, and preferably (a) a suitable intermediary will be found to transport the item from the current holder to the paranoid participant, or (b) the paranoid participant will be given the option to specify what, if any, information should be leaked to the current holder to facilitate the shipping of the item from the current holder to the paranoid participant.

Routing with Paranoid Participants and Symmetric Trust

In cases where trust between implicated participants is symmetric, option (a) above can always be used. Thus, when trust is symmetric, an item can always be routed while respecting a participant's desire for privacy. If a routing conflict exists between the current holder of an item and the destination, then the item is first routed through the owner of the item. Thus the item will now travel from the current holder to the owner and then proceed to the destination. If a routing conflict exists on either of these sub-paths, then the system will attempt to route the item through a third party requestor if one exists in the relevant request. Attached as Appendix D hereto are examples of routing situations involving paranoid participants and symmetric trust according to the preferred embodiment of the present invention.

Routing with Paranoid Participants and Asymmetric Trust

Asymmetric trust means that participant A has indicated trust of participant B, but participant B has not reciprocated. In this situation, participant B may view and request items from participant A, but not vice-versa. Paranoid means that only trusted parties may ship an item to a participant. These two properties can come into direct conflict, creating issues that can only be resolved by the participant. Even in difficult situations where asymmetry/paranoia conflict exists, the present invention provides a methodology for ensuring that there is at least some level of trust in the link between the current holder and the next hop.

The routing methodology preferably allows the paranoid participant to set the parameters of the transportation of the item, thereby providing a heightened degree of confidence in the system while maintaining participant privacy. The following outlines the preferred methodology that occurs when encountering a shipping/trust conflict:
1. Set the request state to “AWAITING_PICKUP”.
2. Notify the paranoid participant.
   a. Briefly state the existence of the shipping conflict,
   b. Present 3 options to resolve conflict.
      i. Add Holder as a Friend
         1. Adds holder as a friend.
         2. Notifies holder to ship item.
      ii. Abort the request.
         1. Aborts the request as usual
      iii. I'll Handle It.
         1. Participant acknowledges that he will arrange for transportation of the item to his satisfaction.
         2. Include information about the current holder
3. Notify the current holder of the item. E.g., “Item X (which you currently have) will be picked up by (Name+E-mail). You should expect to be contacted by this person in the near future.”

Note that in the preferred embodiment, the paranoid participant is given three options to resolve trust conflicts in transporting items, namely, Add Holder as a Friend, Abort the Request or I'll Handle It.

Attached as Appendix E hereto are examples of routing situations involving paranoid participants and asymmetric trust according to the preferred embodiment of the present invention.

Owner Generated Requests

The present invention provides additional methodology for special situations where requests are pre-approved. If a request for an item is made by the owner of the item on behalf of the recipient, approval of the request is assumed because the participant whose approval is required is the one making the request.

Item with a Friend

An owner of an item may wish to assign an item to a friend. It is his prerogative to make a pre-approved request on behalf of the friend. In this case, the requestor of the request is the owner. This action encapsulates request creation, approval, and shipment in one compound action. The newly created request is set to the “En Route” state, and thus still requires the recipient to acknowledge receipt before the item is considered “in use.”. There are no significant changes to the methodology outlined above other than the operation is forbidden if the owner does not possess the item. For example, if the item is in use with another request, the operation is forbidden. If necessary, the owner can “reset” the item if such an allocated request does not really reflect the current location of the item. Resetting an item takes the current request, declares it completed, and marks the item as being with the owner. In other words, resetting the item causes the allocated request to be set to the final, request complete status.

In the preferred embodiment, the operation is permitted even if another request for the item is awaiting pickup or shipment. In this case, the methodology prompts the owner to make sure the owner really wants to perform the operation since another participant may be expecting to physically pick up the item. Again, the litmus test for whether this operation may be performed is whether the system understands the item to be with the owner. If another request for the item has already moved beyond the open block 104 at the time the owner performs this operation, that request will move back to the open block to the top of the queue for that item with the state of its approval still intact and the recipient notified.

In an alternative embodiment, the owner could specifically request that an item be pushed to the owner's friend. Such a request could be performed at any time without any special prompting and would simply create a pre-approved request and process it without any special priority. Any previous requests for the item would not be pre-empted by this push request.

Item with Non-Participant

For the purpose of personal inventory management, an owner may wish to have a record that the owner has lent an item to someone who is not a participant in the system. If this non-participant has an email address, the owner can add the non-participant as a friend and then assign the item to the non-participant. Otherwise, the owner can simply assign the item to the non-participant's name. Assigning the item by email is preferred however, because if the relevant email address joins the system, the record can be converted into a standard full blown request. While an item is with a non-participant, the item becomes inactive and unavailable to be allocated to any requests. Like the “Item with Friend” operation, if the system understands the owner does not have possession of the item, this operation is forbidden.

Collaborative Filtering and Item Proxy

In yet an alternative embodiment, the present invention provides a collaborative filter methodology that allow well-received and recent items to gain the attention of participants through reviews, ratings, newly added items, borrowing activity, and an item proxy system that allows a particular item to not only be an entry in the collection of the participant who owns it but also be an entry in the collection of the friend who currently possesses it. The proxied item is emphasized to the requestor's friends because it shows up as a new item. The proxy system has its own privacy issues that the design addresses.

Access to 2nd Degree Friends

The present invention allows participants to keep their inventory and personal information hidden from non-friends. This limits the dissemination of the participant's personal inventory and other personal information, thereby avoiding potential unsolicited attention. In addition, outside of a participant's local community, it is often difficult to establish the trust required to lend something to a stranger.

The present invention provides for participation of both first degree and second degree friends. As used herein, first degree friends are those friends that a user declares to be friends for purposes of the described system methodology. Second degree friends, or “friends of friends,” are friends of the friends of the participant who are not also friends of the participant. The present invention maintains the inventories in confidence while still allowing service of requests of not only first degree friends but also, after owner approval, second degree friends.

Brokering with Privacy

If a title is not available to a participant through the participant's aggregate inventory, the participant can put the requested title on the wish list. A request on the wish list can be served by a new addition to the participant's aggregate inventory. Additionally, a friend of a friend can serve such a request with a feature called “Brokering with Privacy.” The present invention notifies the participant's friend of the opportunity to broker the transaction without compromising the privacy of the owner of the item. This allows access to multiple degrees of friends, and the sharing of items, without dissemination of any private information absent authorization. If the intermediary agrees to broker the request, that participant becomes the requestor, and is in effect requesting an item from one friend on behalf of another friend.

Proxy Privilege

The proxy privilege provides a participant who borrows an item the power to loan that item to the participant's friends as if the participant owned the item. Access to the item is thus increased to the extent that the recipient's friends are different from the owner's friends. In the preferred embodiment of the present invention there are two opportunities to grant the proxy privilege. First, when an item is requested from its owner, the requestor may ask for the proxy privilege. At this point, privacy considerations may influence requestor's decision. For example, the proxy privilege may expose a participant's borrowing activity to the participant's friends. It may also ameliorate the collaborative filtering effect because the participant would list a new item whether the participant liked it or not. For these privacy reasons, this parameter is false by default. If the owner approves a request that asks for the proxy privilege, the owner may also choose whether or not to grant the proxy privilege. The owner may choose to approve the request but refuse the proxy privilege. Second, while an item is lent out to a participant, the participant may request the proxy privilege for that item. This way, the recipient may evaluate the item before deciding whether the proxy privilege is desirable. This second scenario is only possible where the recipient is trusted by the owner.

In the preferred embodiment, the proxy privilege may not be granted by a proxy. Given that the friends of the proxy may not be able to distinguish between proxied items and items actually owned, requests for proxied items may ask for the proxy privilege. In this situation, the proxy privilege is automatically denied. More particular details of the preferred embodiment are described below.

Ghost Item. The proxy privilege works by adding a copy (or “ghost”) of the original item to the recipient's inventory when the recipient receives both the item and the privilege, and deleting the copy when it is returned from the recipient. Some information will be transmitted between the ghost and original item. Damaged and lost information will be propagated back to the original item, and recall commands will be forwarded to the ghost item.

Visibility. While the recipient has the item, the ghost item will behave just like any other item; it is visible to the recipient's friends and may be requested. However, participants who are friends of both the owner and the recipient will not see the ghost item. Because such participants already have access to the item, it is unnecessary for them to see the ghost copy. A ghost item is considered in use if it has been allocated to a request. While the ghost item is in use, the status of the original item will be considered in use. Because there may be idle time between two requests for the ghost item, the request for the original item may go back and forth between the statuses of “in use” and “idle with borrower”.

Privacy. Because items received with the proxy privilege are visible to a participant's friends, this may influence the participant's decision to ask for the privilege. If the participant does not want others to know about the borrowed item, the participant should not ask for the proxy privilege. Also, unless the privilege has been requested, it preferably cannot be granted.

Recall. If the owner of a proxied item recalls the item, requests for the ghost item may be orphaned. In this situation, the request is converted into a title request, and the requester is notified so that the requester may choose to delete the request. If the requestor does not delete the request, it may match up with other items, or at minimum (if no items exist of the appropriate title) create an opportunity for the friend who acted as proxy to broker a request (as described earlier).

By using the proxy privilege, more participants have access to an item without giving up any privacy. The disadvantage with the proxy privilege embodiment is that it adds potential item latency. For example, if two participants request an item from the owner, the second recipient may experience additional latency due to the circulation of the item among the first recipient's friends. For this reason, the owner may want to decline the proxy privilege if there is high demand for the item.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for asset sharing an item between an item owner and system participants for use with a computer-based system, comprising:
receiving a request from a system participant at the computer-based system;
matching an item in a universe of items associated with the computer-based system with the request;
allocating the matched item to the request;
obtaining approval from the item owner to share the item with the system participant;
transporting the item to the system participant;
monitoring the status of the item; and
transporting the item from the system participant to the item owner or other system participant.

2. The method of claim 1, wherein:
the system participant making the request is the item owner making the request on behalf of a different system participant;
allocating the matched item to the request comprises immediately allocating the matched item to the request; and
transporting the item to the system participant comprises directly transporting the item to the different system participant.

3. The method of claim 1, further comprising adding a new item to the universe of items associated with the computer-based system by:
determining if a title record associated with the item exists;
if a title record associated with the item exists, assigning a preexisting title record identifier to the new item;
if a title record associated with the item does not exist,
creating a title record associated with the new item; and
assigning the newly created title record identifier to the new item.

4. The method of claim 1, wherein:
receiving a request from a system participant at the computer-based system comprises receiving at least one of a title record identifier for a title request or an item record identifier for an item request; and
matching an item in a universe of items associated with the computer-based system with the request comprises:
if the request is a title request, determining whether any item in the universe of items associated with the computer-based system corresponds to the title record identifier associated with the title record request; and
ascertaining whether the system participant requesting the item is trusted by the item owner.

5. The method of claim 1, wherein allocating the matched item to the request comprises evaluating whether an item in the universe of items associated with the computer-based system corresponding to the request to is available by:
determining whether the item is available for allocation to a system participant; and
if the item is available for allocation to a system participant,
ascertaining whether any other request for the item has been previously proscribed; and
if no other request has been previously proscribed, determining whether the request has higher precedence than any other unallocated request competing for the item.

6. The method of claim 5, wherein a request for an item is proscribed by at least one of the following:
the item owner proscribes the request for an item at any time before the item is in transit to the system participant; and
the system participant requesting the item proscribes the next request for an item as part of the initial request.

7. The method of claim 5, wherein determining whether the request has higher precedence than any other unallocated request competing for the item is based on first-in, first-out priority of each item request.

8. The method of claim 5, wherein determining whether the request has higher precedence than any other unallocated request competing for the item is based on a combination of a first-in, first-out priority of each request and the relative location of the requested item and the system participant.

9. The method of claim 1, wherein:
receiving a request from a system participant at the computer-based system comprises receiving at least one of a title request or an item request for a particular item; and
obtaining approval from the item owner to share the item with the system participant comprises:
notifying the item owner that the system participant requests use of the item; and
obtaining a response from the item owner regarding the system participant's use of the item.

10. The method of claim 9, further comprising:
if the system participant request for the item is denied by the item owner and the request was an item request, canceling the system participant's item record request; and
if the system participant request for the item is denied by the item owner and the request was a title request, preventing the same item from matching the system participant's title request in the future.

11. The method of claim 1, wherein transporting the item to the system participant (recipient) comprises:
determining whether the item is in the possession of the recipient; and
if the item has not reached recipient,
identifying the current holder of the item;
calculating a path from the current holder of the item to the recipient;
coordinating the transport of the item along the path from the current holder of the item to the recipient;
monitoring the status of the movement of the item along the path from the current holder of the item to the recipient; and
determining whether the item is in the possession of the recipient.

12. The method of claim 11, wherein transporting the item to the system participant (recipient) further comprises:
determining whether the recipient is privacy sensitive;
if the recipient is privacy sensitive,
determining whether the current holder of the item is trusted by the recipient;
if the current holder of the item is not trusted by the recipient, recalculating a new path from the current holder of the item to the recipient.

13. The method of claim 1, wherein monitoring the status of the item comprises: determining whether the item is in use with the current holder of the item; if the item is not in use with the current holder of the item,
determining whether another request has been matched with the item;
if another request has been matched with the item, coordinating the transport of the item from the current holder of the item to the next system participant slated to receive the item; and
if another request has not been matched with the item,
calculating whether the time that the item has been idle and in possession of the current holder of the item exceeds a predetermined threshold period; and
if the time that the item has been idle with the system participant receiving the item exceeds a predetermined threshold period, coordinating the transport of the item from the system participant to the item owner.

14. The method of claim 1, wherein transporting the item from the system participant to the item owner or other system participant (destination participant) comprises:
determining whether the item is in the possession of the destination participant; and
if the item has not reached the destination participant,
identifying the current holder of the item;
calculating a path from the current holder of the item to the destination participant;
coordinating the transport of the item along the path from the current holder of the item to the destination participant;
monitoring the status of the movement of the item along the path from the current holder of the item to the destination participant; and
determining whether the item is in the possession of the destination participant.

15. The method of claim 14, wherein transporting the item to the item owner or other system participant (destination participant) further comprises:
determining whether the destination participant is privacy sensitive;
if the destination participant is privacy sensitive,
determining whether the current holder of the item is trusted by the destination participant;
if the current holder of the item is not trusted by the destination participant, recalculating a new path from the current holder of the item to the destination participant.

16. The method of claim 1, wherein the item owner is able to immediately recall the item from the system participant.

17. The method of claim 1, wherein the request from a system participant at the computer-based system further comprises a request for a proxy privilege for the system participant to lend the item, and further comprising:
obtaining approval from the item owner for a proxy privilege; and
if approval from the item owner for a proxy privileged is obtained,
adding the item to a proxy inventory of the system participant; and
if the system participant returns the item, removing the item from the proxy inventory of the system participant.

18. A method for asset sharing an item between an item owner and system participants for use with a computer-based system, comprising:
determining if a system participant is included in a universe of system participants trusted by the item owner; and
if the system participant is included in a universe of system participants trusted by the item owner,
allowing the system participant to view a universe of items associated with the item owner;
receiving a request from a system participant at the computer-based system related to the universe of items associated with the item owner;
matching an item in a universe of items associated with the computer-based system with the request;
allocating the matched item to the request;
obtaining approval from the item owner to share the item with the system participant;
transporting the item to the system participant;
monitoring the status of the item; and
transporting the item from the system participant to the item owner or other system participant.

19. The method of claim 18, wherein:
determining if a second system participant is included in a universe of system participants trusted by the first participant;
if the second system participant is included in a universe of system participants trusted by the first participant, allowing the second system participant to request items on behalf of the first participant.

20. A method for matching and allocating assets between an item owner and system participants for use with a computer-based system, comprising:
receiving a request from a system participant at the computer-based system;
determining whether the request corresponds to an item in a universe of available items associated with the computer-based system;
if no item exists in the universe of available items corresponding to the request,
maintaining a record of the request; and
monitoring the universe of available items associated with the computer-based system to determine if an item corresponding to the request is added to the universe of available items; and
if an item exists in the universe of available items corresponding to the request,
matching the item to the request;
allocating the matched item to the request;
obtaining approval from the item owner to share the item with the system participant;
coordinating the transport of the item to the system participant;
monitoring the status of the item; and
coordinating the transport of the item from the system participant to the item owner or other system participant.

21. The method of claim 20, wherein:
the universe of available items corresponding to the request is a function of the system participant; and
determining whether the request corresponds to an item in a universe of available items associated with the computer-based system comprises determining whether the request corresponds to an item in a universe of available items associated with a different system participant.

22. The method of claim 20, further comprising adding a new item to the universe of items associated with the computer-based system by
determining if a title record associated with the item exists;
if a title record associated with the item exists, assigning the preexisting title record identifier to the new item;
if a title record associated with the item does not exist,
creating a new title record associated with the new item; and
assigning the newly created title record identifier to the new item.

23. A system for asset sharing between an item owner and system participants, comprising:
a server component for maintaining a universe of available items and the owner of each item;
a user interface component for receiving a request from a system participant for the use of an item at the server component;
a matching component for determining whether a request from a system participant at the server component corresponds to an item in the universe of available items maintained by the server component;
an allocation component for associating a matched item with a request made by a system participant;
an approval component for obtaining approval from the item owner to share the item with a system participant;
a transportation coordination component for coordinating the transport of the item among an item owner and system participants; and
a monitoring component for monitoring the status of the item.

24. The system of claim 23, wherein the matching component:
maintains a record of title requests received at the user interface component;
monitors the universe of available items maintained at the server component to determine if the requested title is added to the universe of available items; and
if an item matching the title request is added to the universe of available items, initiates the allocation, approval, transportation and monitoring components.
